(19) United States
(12) Patent Application Publication
(10) Pub. No.: US 2019/0278688 A1
(43) Pub. Date: Sep. 12, 2019

(54) SYSTEM AND METHOD FOR TESTING SYSTEM SCALE UP

(71) Applicant: Equalum Ltd., Tel-Aviv (IL)

(72) Inventors: Erez ALSHEICH, Hod Hasharon (IL); Ofir MANOR, Tel-Aviv (IL)

(73) Assignee: Equalum Ltd., Tel-Aviv (IL)

(21) Appl. No.: 16/294,066

(22) Filed: Mar. 6, 2019

Related U.S. Application Data
(60) Provisional application No. 62/640,021, filed on Mar. 8, 2018.

(51) Int. Cl. G06F 11/34; G06F 11/30; G06F 9/46; G06F 16/23

(52) U.S. Cl. CPC G06F 11/3442; G06F 16/2379; G06F 9/466; G06F 11/3024

(57) ABSTRACT

A system and method for simulating data system scaling, including: receiving a first data stream including a plurality of transactions, wherein each of the plurality of transactions includes at least a timestamp and an event, wherein the first data stream is directed at a first system; generating a simulated second data stream based on the first data stream; and configuring a second system to process the second data stream.

### CROSS-REFERENCE TO RELATED APPLICATIONS

This application claims the benefit of U.S. Provisional Application No. 62/640,021 filed on Mar. 8, 2018, the contents of which are hereby incorporated by reference.

### TECHNICAL FIELD

The present disclosure relates generally to big data systems and particularly to simulating data processing system scaling.

### BACKGROUND

Certain transactional systems continuously process data. Websites, for example, have a continuous stream of data, such as click throughs, page requests, and the like. Such systems may require sudden a scale up, e.g., due to unexpected popularity. It is therefore advantageous to know ahead of time what the limits of the system are to allow for better preparation for scale up events. Current systems may suggest, for example, using simulated transactions, but are ill equipped to predict sudden scaling of larger proportions.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for simulating data system scaling, including: receiving a first data stream including a plurality of transactions, wherein each of the plurality of transactions includes at least a timestamp and an event, wherein the first data stream is directed at a first system; generating a simulated second data stream based on the first data stream; and configuring a second system to process the second data stream.

Certain embodiments disclosed herein also include a non-transitory computer readable medium having stored thereon instructions for causing a processing circuitry to perform a process, the process including: receiving a first data stream including a plurality of transactions, wherein each of the plurality of transactions includes at least a timestamp and an event, wherein the first data stream is directed at a first system; generating a simulated second data stream based on the first data stream; and configuring a second system to process the second data stream.

Certain embodiments disclosed herein also include a system for simulating data system scaling, including: a processing circuitry; and a memory, the memory containing instructions that, when executed by the processing circuitry, configure the system to: receive a first data stream including a plurality of transactions, wherein each of the plurality of transactions includes at least a timestamp and an event, wherein the first data stream is directed at a first system; generate a simulated second data stream based on the first data stream; and configure a second system to process the second data stream.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a computing environment for a scale up simulation according to an embodiment.

FIG. 2 is an example graph of a real data stream and plurality of simulated data streams generated therefrom.

FIG. 3 is an example flowchart of a computerized method for testing system scale up according to an embodiment.

FIG. 4 is a block diagram of a simulation server implemented according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Scaling up a system due to increased demand from various resources is a complicated process, as it is often not linear, i.e. twice the processors do not necessarily result in twice the processing speed. Therefore, a simulation server may be used to more accurately predict necessary resources for such an event. The simulation server may be configured to receive a real data stream, including a plurality of transactions, where each transaction includes an event, a timestamp, and possible metadata based on the event. The simulation server generates a simulated data stream based on the real data stream, which may then be processed by a system to determine how various components or KPIs of the system are affected by the simulated data stream.

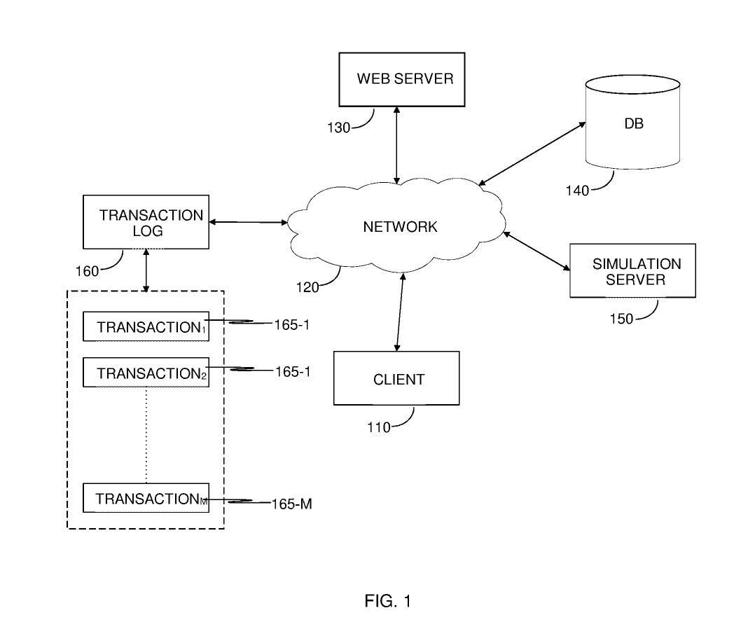

FIG. 1 is a block diagram of a computing environment for a scale up simulation according to an embodiment. A network 120 provides connectivity to a plurality of machines, such as a client device 110, a web server 130, a database server 140, a simulation server 150, and the like. In some embodiments, a plurality of each of the above mentioned elements may be utilized, while here one of each is shown merely for simplicity and to provide an example.

In an embodiment, the network 120 may be configured to provide connectivity of various sorts, as may be necessary, including but not limited to, wired and/or wireless connectivity, including, for example, local area network (LAN), wide area network (WAN), metro area network (MAN), worldwide web (WWW), Internet, and any combination thereof, as well as cellular connectivity.

A client device 110 requests access to data from a web server 130. The web server 130 provides the data to the client device 110, and may log the request, for example in a transaction log 160. The transaction log 160 may contain therein a plurality of transactions 165-1 through 165-M, where ‘M’ is an integer number equal to or greater than 1. A transaction 165 may contain a record of an event, such as user requests, changes made to a database, operations performed on a table of a database, access requests, and the like. Typically, transactions include a timestamp and an event. In other embodiments the client device 110 may send a query or operation to the database server 140 to be executed on one or more tables stored thereon. The database server 140 may store a transaction between the client device 110 and the one or more tables of the database server 140 in the transaction log 160. The transaction log 160 may be stored on a persistent storage, object storage, storage device of the database server 140, storage device of the web server 130, and the like. In some embodiments the transaction log 160 may be stored on a distributed storage.

A simulation server 150 connected to the network 120 may simulate a plurality of transactions, also called a data stream. A data stream includes a plurality of transactions, which may or may not be related to each other. Typically the transactions are arranged in ascending or descending temporal order.

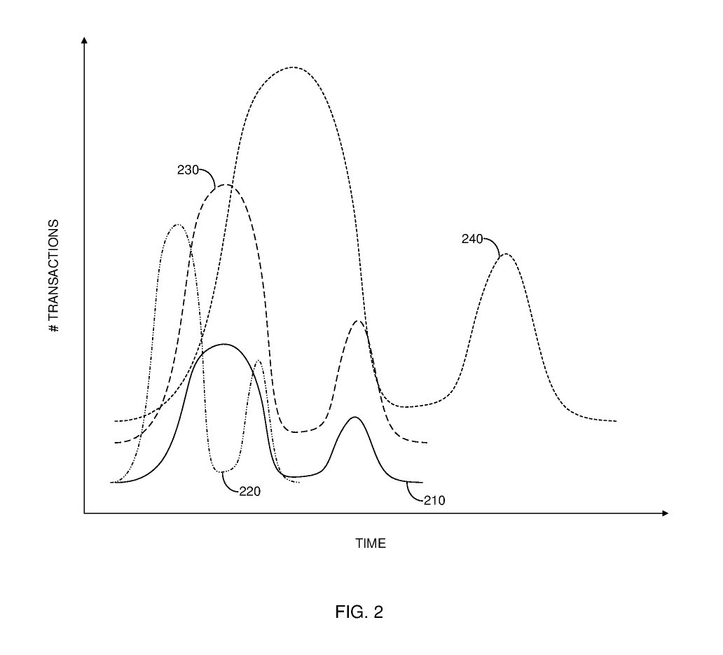

FIG. 2 is an example graph of a real data stream, and a plurality of simulated data streams generated therefrom. In this embodiment, a real data stream 210 is a graph line plotting a number of transactions as a function of time. A simulation server, e.g., the simulation server 150 of FIG. 1, is configured to generate a simulated data stream from the real data stream 210.

A simulated data stream is generated, for example, to test a system's robustness, its load handling capabilities, and the like. This way, the system operator is aware of the maximum (or minimum) components a system requires to function within defined parameters. For example, an e-commerce website may have a relatively low load (as measured by server CPU load, memory load, and the like) on any given day, but expects a higher load during a holiday season or sale event when users shop more. In order to effectively predict if the system will be able to handle the higher load, it may be useful to simulate a data stream created by a higher number of users accessing the site, for example, completing purchases, updating the necessary database tables which indicate price, quantity, and the like.

One solution includes generating such simulated data by determining general attributes of the data stream and generating a completely simulated data stream based on the attributes. However, this may have a disadvantage of using non-real data, i.e. data that was not generated by real human users based on real human behavior. Real data may contain more nuanced behavior which is not immediately apparent to a human operator, or to a machine or artificial intelligence attempting to simulate such data streams. Therefore, the simulation server 150 generates simulated data streams based directly on the real data stream, for example by altering timestamps of the real data stream, and duplicating transactions of the real data stream.

For example, a first simulated data stream 220 is generated by altering the timestamps of the real data stream 210. In this example, the simulated data stream 220 runs the same transactions as the real data stream, such that the simulated data stream is faster than the real data stream. As another example, a second simulated data stream 230 is generated by the simulation server 150 such that a portion of the transactions of the real data stream 210 are duplicated without altering their timestamp. This approach allows the simulation to retain peak loads at the same time as they normally occur, however it requires storing more information due to the duplicate transactions. In yet another example, simulated data stream 240 is generated by the simulation server by both duplicating transactions and altering their time stamp, which preserve the total behavior (i.e. shape) of the line graph. Each of these methods of simulating data streams utilizes the real data stream, and may have different advantages depending on what the system, or users of the system, wish to test.

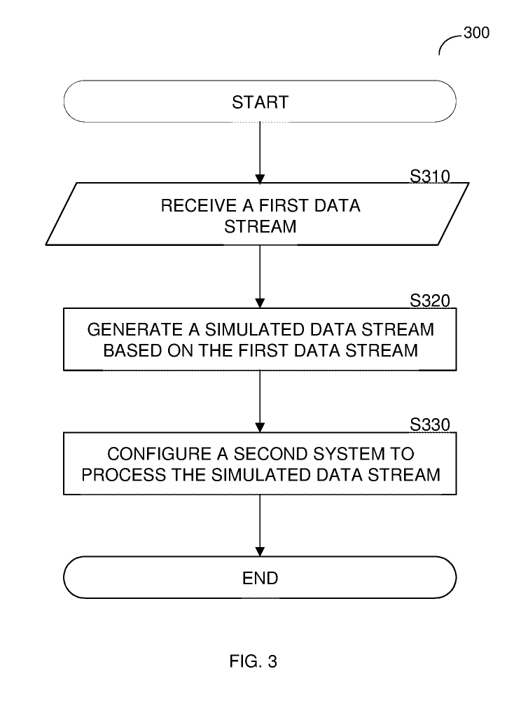

FIG. 3 is an example flowchart 300 of a computerized method for testing and simulating a system scale up, implemented in accordance with an embodiment.

At S310, a first real data stream is received, e.g., by a simulation server. The simulation server may be communicatively coupled for example to one or more transaction logs, each containing one or more data streams of a first system. A data stream includes a plurality of transactions, each transaction including an event and a timestamp at which the event occurred.

At S320, a simulated data stream is generated, e.g., by the simulation server, based on the real data stream. The simulated data stream includes transactions from the real data stream. In an embodiment, the simulated data stream may be generated by altering the timestamps of at least a portion of the transactions of the real data stream, such that the simulated data stream is faster than the first real data stream. A faster data stream is not necessarily a data stream which is processed faster, but rather one where the time window from start of the data stream to the end is shorter, e.g., more events occur per time unit on average.

For example, a real data stream may include two transactions, a first happening at t0, and a second happening at t1, where t1>t0. A simulated data stream may alter the timestamps, such that the first transaction happens at t0′ and the second occurs at t2, where t0′<t2<t1. There is not necessarily a relationship between t0 and t0′. In another embodiment, the simulated data stream may be generated by duplicating at least a portion of the transactions. For example, every transaction may be duplicated to twice, so that twice the number of transactions (relative to the real data stream) should be processed within the same amount of time. In yet another embodiment, the simulated data stream may be generated by duplicating at least a portion of the transactions, and further by altering the timestamps of at least another portion of the transactions, wherein a transaction may be both duplicated and have its timestamp altered, only be duplicated, only have its timestamp altered, or neither duplicated nor have its timestamp altered.

At S330, the simulated data stream is processed. In an embodiment, a second system executes the processing, where the second system is identical to the first system. In some embodiments, the second system may be the first system. It may be advantageous to configure the first system to set up secondary components, e.g., memory space, storage space, database tables and the like. This is useful when testing load (for example on CPU and memory) without wanting to commit to an operational database, for example, transactions which are within a simulation. In some embodiments, the simulation server may further add a tag, flag, or other identifier to the simulated transactions, to allow the system to later disregard them, and/or delete them from memory, storage, etc.

In some embodiments, the simulation server may determine in real time a live data stream (i.e., occurring in real time), and supplement the live data stream with a simulated data stream, wherein the simulated transactions are flagged as simulated in order to disregard their effect on real data. This allows for the measuring of the load on components of the system, e.g., CPU and memory, without disrupting normal functionality thereof.

In yet other embodiments the simulated data stream may include both real and simulated transactions, wherein the simulated transactions have not occurred, and are generated by the simulation server, for example based on attributes of the data stream. For example, a machine learning system, such as a neural net, may be trained to detect patterns in a data stream, and then generate a simulated data stream based on the detected patterns. This results in a machine simulated data stream, which may be combined with a real data stream to produce a simulated data stream for testing system robustness and scale up capability, as detailed further herein.

In some embodiments, a measurement may be generated for a KPI (key performance indicator). A KPI may be, for example, processor usage, memory usage, storage usage, speed of writing to a database, number of user requests received, and the like. The measurement may be generated based on a simulated data stream, a live data stream, and the like. A KPI result which is based on a simulated data stream may be referred to as a simulated KPI, in an exemplary embodiment. In certain embodiments, a KPI may be generated based on a live data stream, and compared to a simulated KPI of a simulated data stream. A match score may be generated, for example, to determine a difference. If the difference is below a threshold value, the KPIs may be converging. In such a case, the system may generate a prediction, such as a load prediction, based on the KPI and the live data stream. For example, the system may predict that the processor(s) will be at full capacity if the current number of requests continues to grow at the predicted pace. This is due to having already simulated a data stream having a similar characteristic (i.e. KPI value). In an embodiment, the system ceases processing the simulated data stream when a threshold value is exceeded.

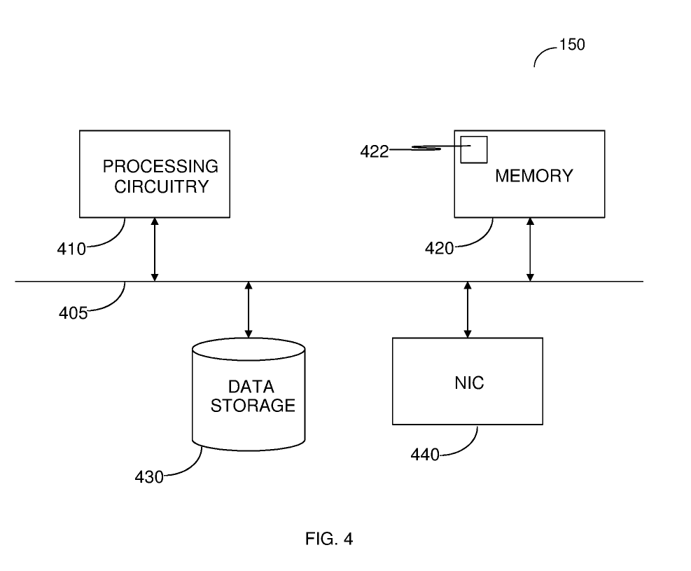

FIG. 4 is a block diagram of a simulation server 150 implemented according to an embodiment. The server 150 includes at least one processing circuitry 410, for example, a central processing unit (CPU). In an embodiment, the processing circuitry 410 may be, or be a component of, a larger processing unit implemented with one or more processors.

The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing circuitry 410 is coupled via a bus 405 to a memory 420. The memory 420 may include a memory portion 422 that contains instructions that, when executed by the processing circuitry 410, performs the method described in more detail herein. The memory 420 may be further used as a working scratch pad for the processing circuitry 410, a temporary storage, and others, as the case may be. The memory 120 may be a volatile memory such as, but not limited to random access memory (RAM), or non-volatile memory (NVM), such as, but not limited to, Flash memory.

The processing circuitry 410 may be further coupled with a data storage 430. Data storage 430 may be used for the purpose of holding a copy of the method executed in accordance with the disclosed technique. The data storage 430 may include a storage portion containing a first data stream, and a simulated data stream generated based on the first data stream.

The processing circuitry 410 is further coupled with a network interface controller (NIC) 440, which provides connectivity, for example to a network 120 as detailed in FIG. 1 above. The processing circuitry 410 and/or the memory 420 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described in further detail herein.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for simulating data system scaling, comprising:
receiving a first data stream including a plurality of transactions, wherein each of the plurality of transactions includes at least a timestamp and an event, wherein the first data stream is directed at a first system;
generating a simulated second data stream based on the first data stream; and
configuring a second system to process the second data stream.

2. The method of claim 1, further comprising:
measuring the load on components of the second data system based on the processed second data stream.

3. The method of claim 1, wherein generating the simulated second data stream further comprising:
altering at least a portion of the timestamps of a first portion of the plurality of transactions such that the second data stream spans a total time shorter than the first data stream; and
duplicating at least a second portion of the plurality of transactions.

4. The method of claim 1, further comprising:
generating a second plurality of transactions based on the first plurality of transactions; and
generating the second data stream further based on the second plurality of transactions.

5. The method of claim 1, further comprising:
generating a measurement based on a key performance indicator (KPI) of the second data stream.

6. The method of claim 5, wherein the KPI is based on a measurement of a load any one of: a processor, a memory, and a storage.

7. The method of claim 5, further comprising:
causing the second data system to cease processing of the second data stream when a KPI value does not meet a threshold.

8. The method of claim 1, wherein the second system is any one of: the first system, a system different than the first system, and a combination of the first system and the second system.

9. The method of claim 1, wherein the second system comprises the first system, utilizing secondary components.

10. The method of claim 1, further comprising:
causing the second system to process a real time data stream together with the second data stream, wherein the second data stream is generated in real time to supplement the real time data stream.

11. A non-transitory computer readable medium having stored thereon instructions for causing a processing circuitry to perform a process, the process comprising:
receiving a first data stream including a plurality of transactions, wherein each of the plurality of transactions includes at least a timestamp and an event, wherein the first data stream is directed at a first system;
generating a simulated second data stream based on the first data stream; and
configuring a second system to process the second data stream.

12. A system for simulating data system scaling, comprising:
a processing circuitry; and
a memory, the memory containing instructions that, when executed by the processing circuitry, configure the system to:
receive a first data stream including a plurality of transactions, wherein each of the plurality of transactions includes at least a timestamp and an event, wherein the first data stream is directed at a first system;
generate a simulated second data stream based on the first data stream; and
configure a second system to process the second data stream.

13. The system of claim 12, wherein the system is further configured to:
measure the load on components of the second data system based on the processes second data stream.

14. The system of claim 12, wherein the system is further configured to:
alter at least a portion of the timestamps of a first portion of the plurality of transactions such that the second data stream spans a total time shorter than the first data stream; and
duplicate at least a second portion of the plurality of transactions.

15. The system of claim 12, wherein the system is further configured to:
generate a second plurality of transactions based on the first plurality of transactions; and
generate the second data stream further based on the second plurality of transactions.

16. The system of claim 12, wherein the system is further configured to:
generate a measurement based on a key performance indicator (KPI) of the second data stream.

17. The system of claim 16, wherein the KPI is based on a measurement of a load any one of: a processor, a memory, and a storage.

18. The system of claim 16, wherein the system is further configured to:
cause the second data system to cease processing of the second data stream when a KPI value does not meet a threshold.

19. The system of claim 12, wherein the second system is any one of: the first system, a system different than the first system, and a combination of the first system and the second system.

20. The system of claim 12, wherein the second system comprises the first system, utilizing secondary components.

21. The system of claim 12, wherein the system is further configured to:
cause the second system to process a real time data stream together with the second data stream, wherein the second data stream is generated in real time to supplement the real time data stream.
